(19) United States
(12) Patent Application Publication
(10) Pub. No.: US 2021/0145172 A1
(43) Pub. Date: May 20, 2021

(54) MODULAR FRAME ASSEMBLY

(71) Applicant: Central Graphics and Container Group Ltd., Mississauga, Ontario (CA)

(72) Inventors: Domenic Cecol, Mississauga, Ontario (CA); Joel Pollock, Mississauga, Ontario (CA)

(73) Assignee: Central Graphics and Container Group Ltd., Mississauga, Ontario (CA)

(21) Appl. No.: 17/252,642

(22) PCT Filed: Jun. 14, 2019
(86) PCT No.: PCT/CA2019/050841

§ 371 Date: Dec. 15, 2020

Related U.S. Application Data
(60) Provisional application No. 62/685,590, filed on Jun. 15, 2018.

(51) Int. Cl. A47B 87/02; A47B 47/00

(52) U.S. Cl. CPC A47B 87/0215; A47B 47/00

(57) ABSTRACT

A modular frame assembly is disclosed. The assembly includes a plurality of supports, and at least one connector for interconnecting the supports. The connector includes a base, a plurality of legs extending outwardly from the base, each leg defining a socket having an exterior surface that has a generally constant profile throughout the length of the leg, and a member that is movable between an engaged position in which it projects interiorly of the leg, and a disengaged position in which it is flush with the exterior surface, the member being biased to the disengaged position. Additional components, such as shelf supports, mounting brackets, shelf brackets, and risers, can be included in the assembly. The modular nature of the assembly allows for a wide arrangement of structures to be created.

### FIELD OF THE INVENTION

The present invention relates to the field of modular frame and shelving assemblies.

### BACKGROUND OF THE INVENTION

Shelf assemblies are particularly advantageous for displaying goods for sale in commercial settings, and are also useful for storing items in closets, garages, and the like. Modular type shelving units have gained popularity for their versatility. This type of shelving allows for a near unlimited number of shapes and sizes to be constructed, while minimizing the amount of inventory that needs to be kept on hand.

### SUMMARY OF THE INVENTION

According to one aspect of the invention, there is provided a modular frame assembly. The assembly comprises a plurality of supports, and a connector for interconnecting the supports.

According to another aspect, the connector may comprise a base member; and a plurality of legs extending outward from the base member, each leg forming a male coupling configured to connect with a female coupling on the support; wherein each leg includes a resilient member that is deformed when the leg is coupled with the support.

According to another aspect, the assembly may further comprise a sleeve configured to be slidably mounted over the support. A shelf support may be mounted to the sleeve. The shelf support may comprise a post normal to an upper face of the shelf support.

According to a further aspect, there is provided a connector. The connector comprises a base; a plurality of legs extending outwardly from the base, each leg defining a plug having an exterior surface that has a generally constant profile throughout the length of the leg; and a member that is movable between an engaged position that projects interiorly of the exterior surface and a disengaged position that is flush with the exterior surface, the member being biased to the engaged position.

According to a further aspect, the outer surface of the resilient member may have a gripping element, and the gripping element may extend outward from the face of the leg. The gripping element can be a barb.

In another embodiment, the modular frame assembly may further comprise a mounting bracket. The mounting bracket comprises a longitudinal member, which includes a cuff along the length of a first side that slidably engages the support, and a track along the length of a second side.

The modular frame assembly may include an adjustable shelf bracket, the adjustable shelf bracket comprises a shelf bracket face; a brace plate extending downwardly forming a generally cantilevered structure; and at least one guide connected to the brace plate that is received by the track.

According to a further aspect, there is provided a kit for constructing a frame assembly, the kit comprising a plurality of supports, and a connector for interconnecting the supports. The kit may also comprise a shelf support, a mounting bracket, and/or an adjustable shelf bracket.

### BRIEF DESCRIPTION OF THE DRAWINGS

In the drawings:

FIG. 1A is a perspective view of an assembly according to an embodiment of the invention;

FIG. 1B is an exploded view of the assembly shown in FIG. 1A;

FIG. 1C is a partial exploded view of segment A from FIG. 1B;

FIG. 2 is a perspective view of a connector according to an embodiment for use in the assembly;

FIG. 3A is a top view of the connector shown in FIG. 2;

FIG. 3B is a section view of the connector along line F-F in FIG. 3A;

FIG. 4 is a perspective view of the connector shown in FIG. 2;

FIG. 5 is a perspective view of the connector shown in FIG. 2;

FIGS. 6A to 6N are perspective views of connectors according to different embodiments of the invention;

FIG. 7A is a top partial view of an assembly according to an embodiment;

FIG. 7B is a section view along line P-P in FIG. 7A;

FIG. 7C is an enlarged view of segment W from FIG. 7B;

FIGS. 8A-8D are perspective views of a shelf support according to an embodiment for use in the assembly;

FIG. 9 is a perspective view of a shelf support according to another embodiment;

FIG. 10 is a perspective view of a shelf support according to another embodiment;

FIG. 11 is a perspective view of a shelf support according to another embodiment;

FIG. 12A is a perspective view of a right shelf bracket according to an embodiment for use in the assembly;

FIG. 12B is a perspective view of a left shelf bracket according to another embodiment;

FIG. 12C is a perspective view of a shelf support according to yet another embodiment;

FIG. 13A is a top perspective view of a corner connector with shelf support according to an embodiment;

FIG. 13B is a bottom perspective view of the corner connector with shelf support shown in FIG. 13A;

FIG. 14A is a perspective view of a shelf support bracket according to another embodiment;

FIG. 14B is a perspective view of a shelf support bracket according to another embodiment;

FIG. 15A is a top perspective view of a shelf support riser according to an embodiment;

FIG. 15B is bottom perspective view of the shelf support riser shown in FIG. 15A;

FIG. 15C is a perspective view of a shelf support riser engaged with a shelf support according to an embodiment of the invention;

FIG. 16A is a partial view of an assembly according to an embodiment;

FIG. 16B is an exploded view of the assembly shown in FIG. 11A;

FIG. 17A is a top partial view of an assembly according to an embodiment;

FIG. 17B is a section view along line K-K of FIG. 12A;

FIG. 17C is an enlarged view of segment M from FIG. 12B;

FIG. 18 is a perspective view of a mounting bracket according to an embodiment for use in the assembly;

FIG. 19 is a perspective view of a shelf bracket according to an embodiment;

FIG. 20 is a view of a mounting bracket and a shelf bracket on a support;

FIG. 21A is a section view of a mounting bracket and a shelf bracket on a support;

FIG. 21B is a section view of a mounting bracket and a shelf bracket on a support;

FIG. 22A is a perspective view of a miter connection between two supports according to an embodiment;

FIG. 22B is an exploded view of the miter connection shown in FIG. 22A;

FIG. 22C is a section view of the miter connection shown in FIG. 22A;

FIG. 23A is a partial view of an assembly according to an embodiment;

FIG. 23B is a partially exploded view of FIG. 23A, showing a foot cap;

FIG. 23C is a section view of the partial assembly shown in FIG. 23A;

FIG. 24A is a partial view of an assembly according to an embodiment;

FIG. 24B is a partially exploded view of FIG. 24A, showing a foot;

FIG. 24C is a section view of the partial assembly shown in FIG. 24A;

FIG. 25A is a partial view of an assembly according to an embodiment including a caster adaptor;

FIG. 25B is a section view of the partial assembly shown in FIG. 25A;

FIG. 26A is a front perspective view of a capped caster adapter;

FIG. 26B is an exploded view of the caster adapter of FIG. 26A;

FIG. 26C is back perspective view of the caster adapter of FIG. 26A;

FIG. 27A is a perspective view of a corner joint from an assembly according to an embodiment;

FIG. 27B is a partially exploded view of FIG. 27A, showing fasteners that secure supports to a connector;

FIG. 27C is a section view of the corner joint shown in FIG. 27A;

FIG. 28A is a partial view of an open shelving from an assembly according to an embodiment;

FIG. 28B is a partially exploded view of the open shelving shown in FIG. 28A;

FIG. 29A is a partial view of an open shelving from an assembly according to another embodiment;

FIG. 29B is a section view of the open shelving shown in FIG. 29A;

FIG. 29C is an exploded view the open shelving shown in FIG. 23A; and

FIGS. 30 to 49 are views of various assemblies according to further embodiments of the invention.

### DETAILED DESCRIPTION OF THE EMBODIMENTS

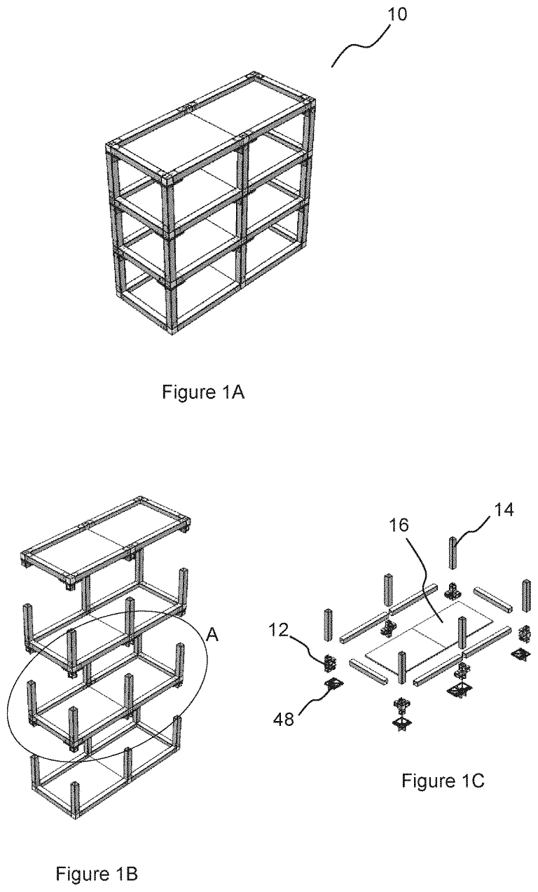

A frame assembly 10 according to an embodiment of the present invention is shown in FIGS. 1A-C. The assembly 10 includes a plurality of vertical and horizontal supports 14 linked together by connectors 12 to form the frame assembly 10. Shelving members 16 can be attached or mounted directly or indirectly to the supports 14.

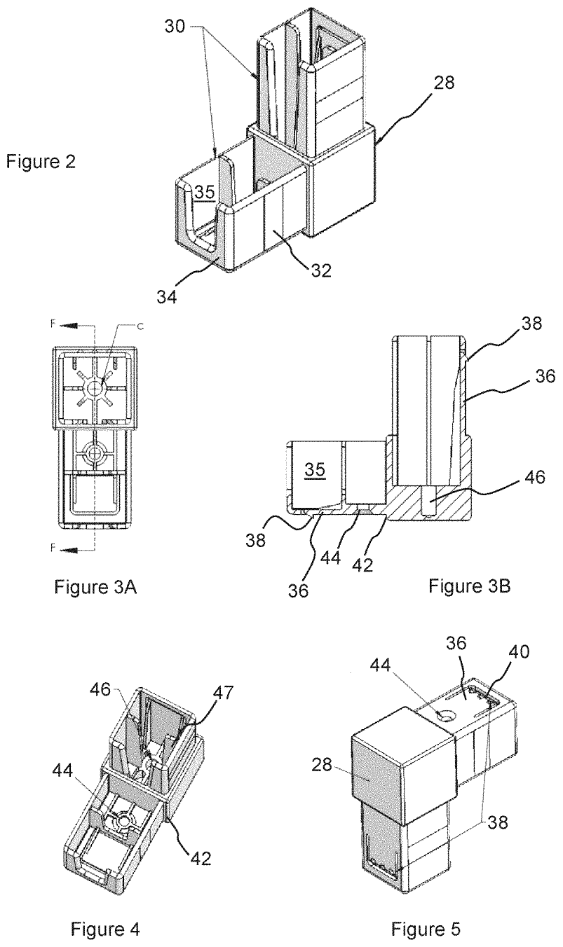

A connector 12 has a base 28, which in FIG. 2 to 5 is shown as generally cube-shaped, and legs 30 extend from one or more faces of the base 28.

The supports 14 have a substantially square cross section, providing for four walls 18, an exterior surface 20 and an interior surface 22. The edges 24 of each end defines an opening 26 that is dimensioned to form a female coupling that matingly receives a leg 30 from a connector 12.

Each leg 30 is defined by a plurality of side faces 32 and an end face 34, which define a hollow socket 35 therein. The legs are shaped and dimensioned to form a male coupling that is received by an opening 26 of the support 14. On at least one side face 32 of the leg 30 is a resilient member 36 that is able to flex in response to pressure. The resilient member 36 is a tab defined by a U-shaped void in a face of the leg 30, creating a free end 40. At least one gripping element 38 having a sharp projection, such as a barb, extends outward from the resilient member 36, and is preferably located near the free end 40 of the resilient member 36.

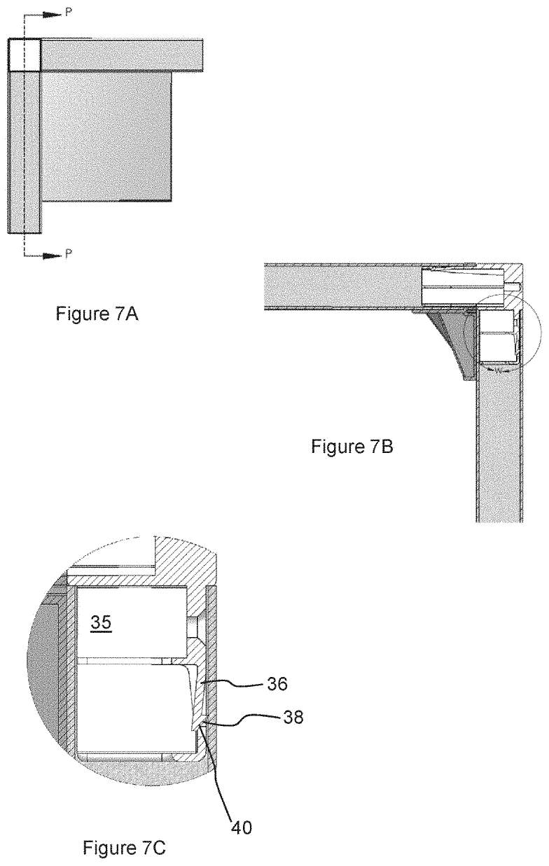

The resilient member 36 is biased to be in a first position, in which it is substantially planar with the face of the leg 30 (see e.g. FIG. 3B). When the leg 30 is received by a support 14 as shown in FIG. 7B, the interior surface 22 of the support 14 applies pressure to the resilient member 36 through contact with the gripping element 38. This pressure moves the resilient member 36 into a second position, in which the free end 40 of the resilient member flexes inward (see e.g. FIG. 7C).

While the resilient member 36 is in the second position, the gripping element 38 no longer serves as an impediment, and the support 14 can slide over the leg 30. Once the leg 30 has been received by the support 14, the gripping element 38 engages with the interior surface 22 of the support 14. The engagement of the gripping element 38 with the interior surface of the support 14 creates resistance to the removal of the support 14 from the leg 30 of the connector 12, thereby coupling the support 14 to the connector 12.

The leg 30 has a smaller perimeter than the face of the base 28 from which it extends, which creates an abutment 42. When a leg 30 is received by a support 14, the edges 24 from the support 14 approach or contact the abutment 42, creating a substantially flush connection between the base 28 and the support 14.

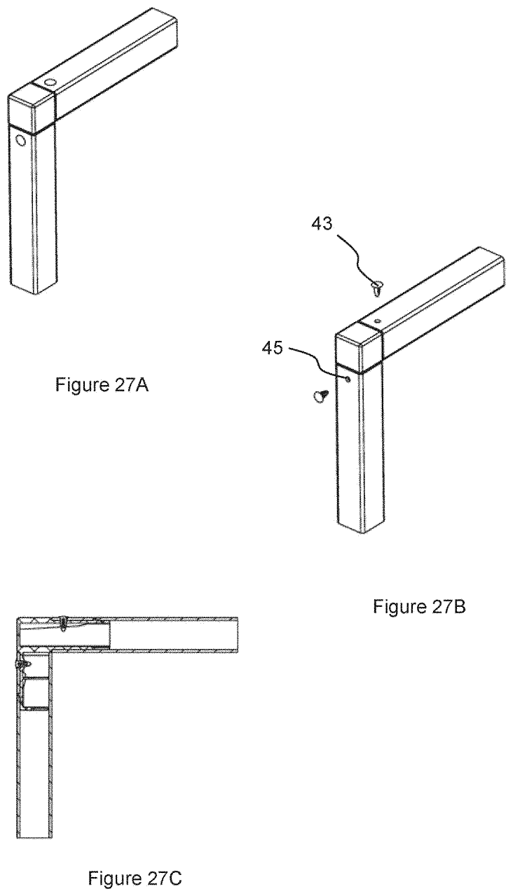

After the support 14 has been placed over the leg 30, a fastener 43 can be used to further secure the support 14 to the connector 12 (see e.g. FIGS. 27A-27C). The fastener can be received by a hardware aperture 44 in a leg 30 of the connector 12. A corresponding aperture 45 can also be present in the support 14.

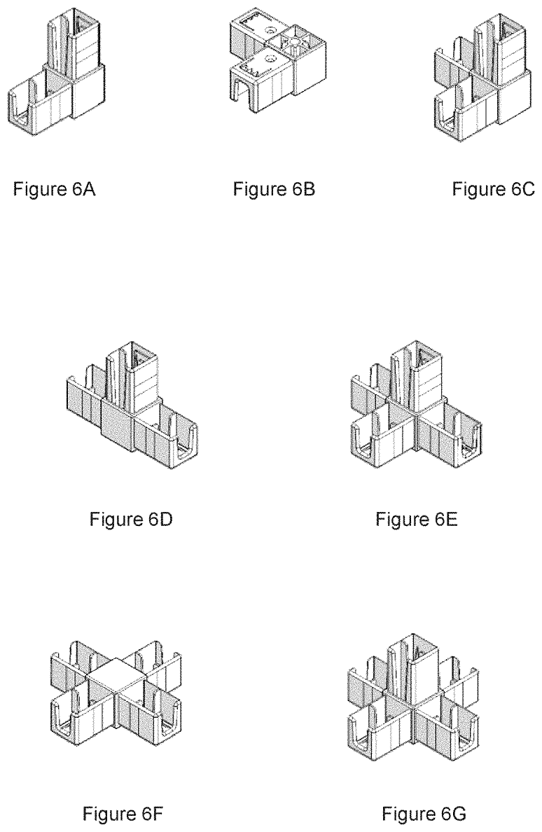

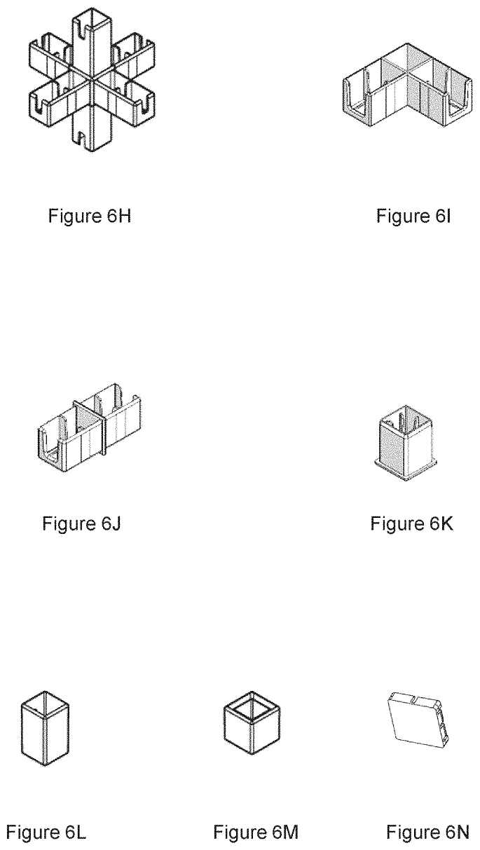

As can be seen in FIGS. 6A-6K, legs 30 extend from one or more faces of the base 28, depending on what role the connector 12 will have in the assembly 10. For example, FIGS. 6A-6C illustrate a corner connector 12; FIGS. 6D and 6E illustrate middle connectors 12; FIGS. 6F-6H illustrate central connectors 12, which would be located in the interior of an assembly 10; FIG. 6J illustrates connector 12 that can longitudinally connect two supports 14; and FIG. 6K illustrates a connector 12 having a single leg 30 extending from the base, which would primarily be used as a plug to cap an open end of a support 14.

The base of connectors 12 that are to form the lower level of the assembly 10, such as those shown in e.g. FIGS. 6A to 6E, may include a caster aperture 46 to receive and secure a caster wheel (not shown). In addition, the plug shown in FIG. 6K may also have a caster aperture 46 as can be seen in FIG. 26B.

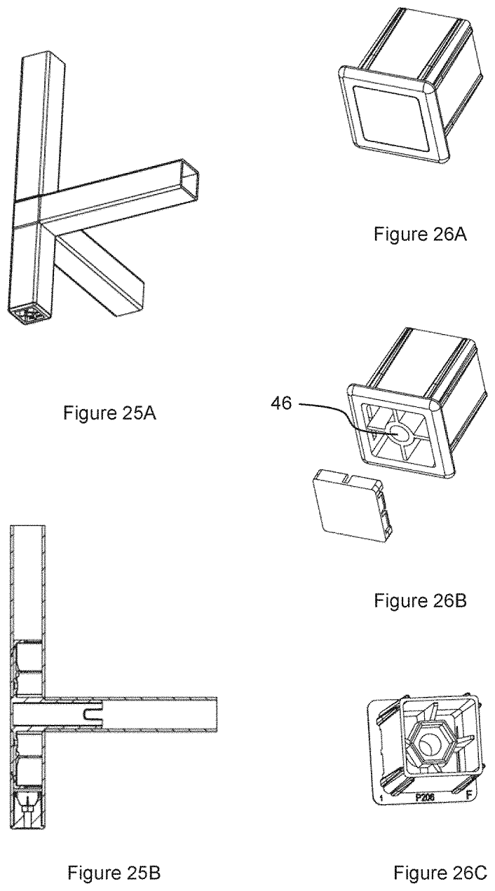

Installing the plug into the bottom of a foot support will allow the installation of caster wheels onto the structure (see FIGS. 25A-B). A cap 47 (FIGS. 6N and 26A-B) can be used to cover the caster aperture 46 by way of e.g. a snap fit.

FIGS. 6L and 6M illustrate types of feet that can be used in the assembly 10. Each foot is defined by side walls and an end wall having an opening on one end. The dimensions between the feet shown in FIGS. 6L and 6M differ based on the intended use of the feet.

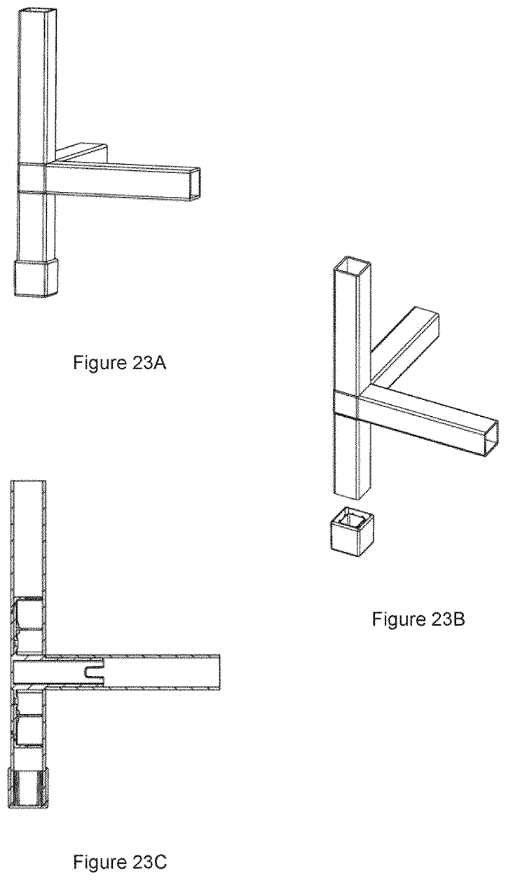

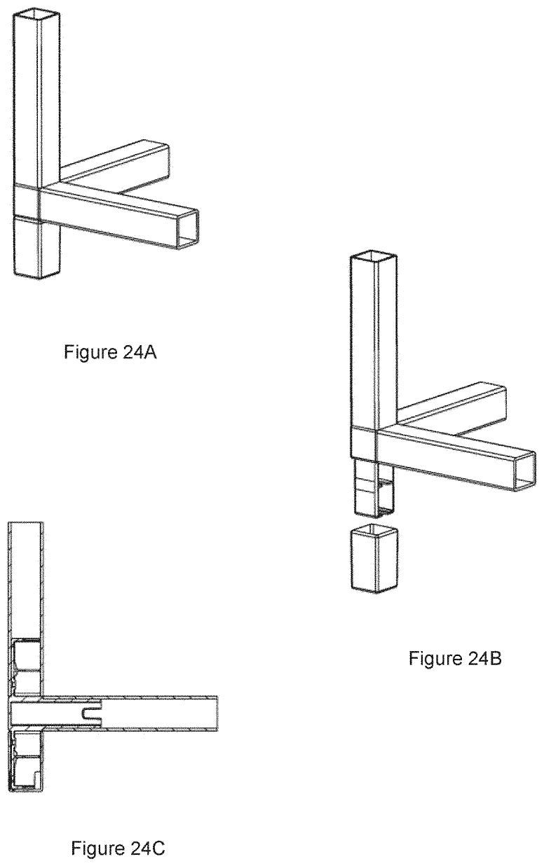

The foot shown in FIG. 6L is further shown in FIGS. 24A-24C, in which it can be seen that it defines a hollow interior having an open end and a closed end. The foot engages with the leg of the connector as shown in FIG. 24B. The foot shown in FIG. 6M defines a hollow interior having an open and a closed end. However, this foot is dimensioned to engage with and receive the end of a support 14 as can be seen in FIGS. 23A-23C.

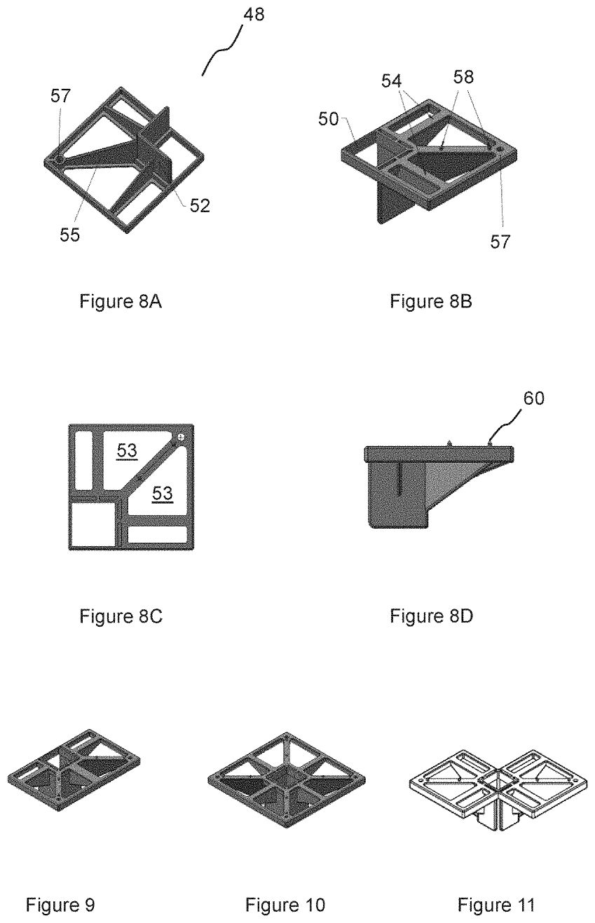

The assembly 10 may include a shelf support 48 (see FIGS. 8 to 11). The shelf support 48 includes a collar 50 that is dimensioned to snugly fit around the perimeter of a support 14. A sleeve 52 extends downward from at least one side of the collar 50. Connected to the collar 50 are a plurality of shelf support ribs 54 that interconnect to collectively define a seat 56. Struts 55 connect the underside of the shelf support ribs 54 to the sleeve 52 creating a generally cantilevered structure.

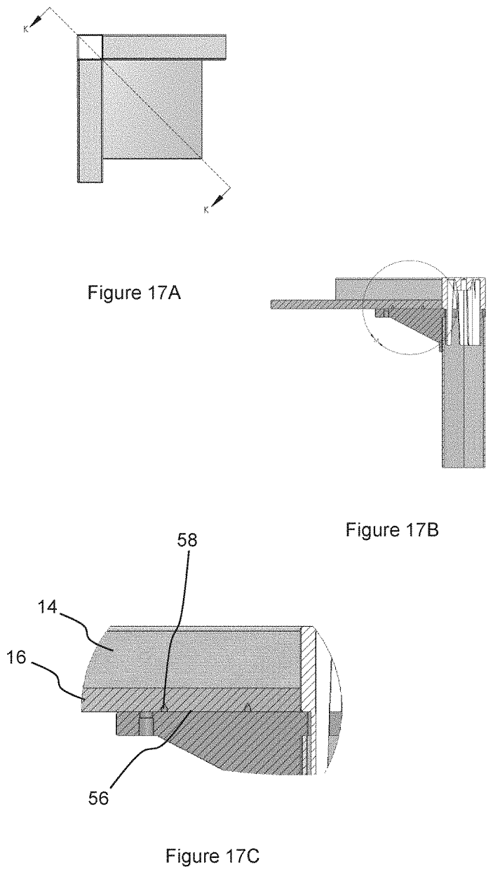

The shelf support ribs 54 define an upper face of the seat 56 receives a shelving member 16. At least one post 58, having a pointed tip 60, extends upwardly from the face of the seat 56. As can be seen in FIGS. 17B-17C, when a shelving member 16 is placed on the seat 56, the pointed tip 60 of the post 58 pierces the underside of the shelving member 16, and aids in securing the shelving member 16 in place.

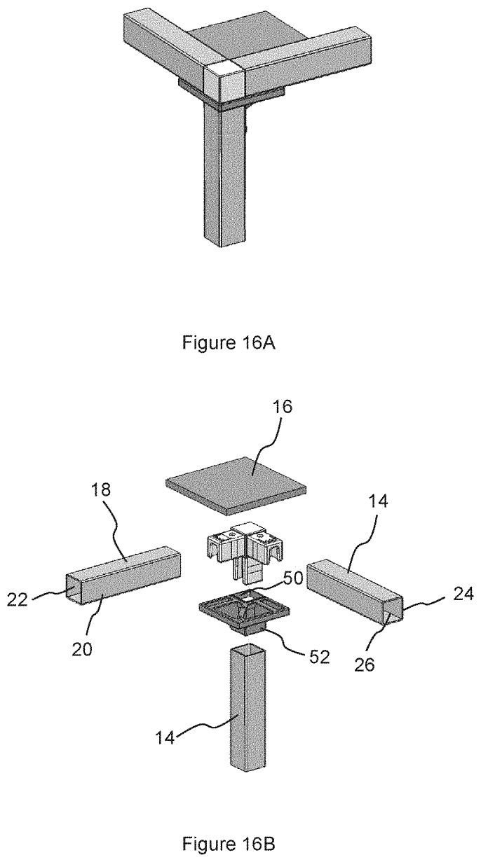

FIGS. 16A-16B illustrate a shelf support 48 in use in the assembly 10, in which the collar 50 is placed over the vertical support 14. When a shelving member 16 is placed on the seat, a portion of the weight from the shelving member 16 is transferred through the struts 55 and sleeve 52 to the vertical support 14.

The shape and dimension of the seat 56 may take a number of forms relating to the nature and intended use of the shelf support 48. FIGS. 8A-8D illustrate a corner shelf support 48, in which the sleeve 52 extends downward from two sides of the collar 50 and the shelf support ribs 54 extend from same two sides of the collar 50 to form the seat 56.

FIG. 9 illustrates a double-sided shelf support 48, in which the sleeve 52 extends downward from three sides of the collar 50 and the shelf support ribs 54 extend from same three sides of the collar 50 to form the seat 56.

FIG. 10 illustrates a central shelf support 48, in which the shelf support ribs 54 extend from all sides of the collar 50. In this embodiment, the sleeve 52 extends downward from all sides of the collar 50 and the shelf support ribs 54 extend from all sides of the collar 50 to form a seat 56 that surrounds the collar 50.

FIG. 11 illustrates a split corner shelf support 48, which is effectively two opposing corner shelf supports joined together. The sleeve 52 extends downward from all sides of the collar 50, and the ribs 54 form two distinct corner shelf support seats 56 extending from opposing corners of the collar 50.

After the shelving member 16 has been placed on the seat 56, a fastener can be used to further secure the shelving member 16 to the shelf support 48. The fastener can be received by a hardware aperture 57 in the shelf support 48, which may be formed by the shelf support ribs 54. A corresponding aperture (not shown) can also be present in the shelving member 16.

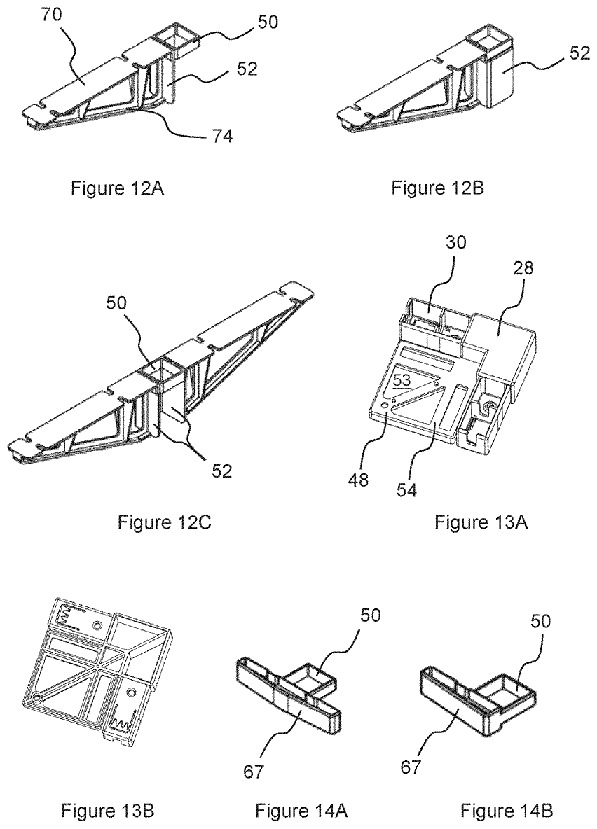

FIGS. 12A to 12C illustrate a shelf bracket 66 for use in the assembly 10. This embodiment of the shelf bracket 66 includes a collar 50 and a sleeve 52 that extends downwardly therefrom. The location of the collar 50 may vary dependent upon if the shelf bracket 66 is intended to support the left side of the shelving member 16 (FIG. 12B) or the right side of the shelving member 16 (FIG. 12A). The shelf bracket 66 is generally L-shaped forming a cantilevered structure, having a shelf bracket face 70 that is substantially perpendicular with the sleeve 52. A plurality of struts 74 connect the underside of the shelf bracket face 68 and sleeve 52. Alternatively, the shelf bracket 66 may be double-sided as shown in FIG. 12C, in which two distinct brackets 66 extend from opposing sides of the collar 50.

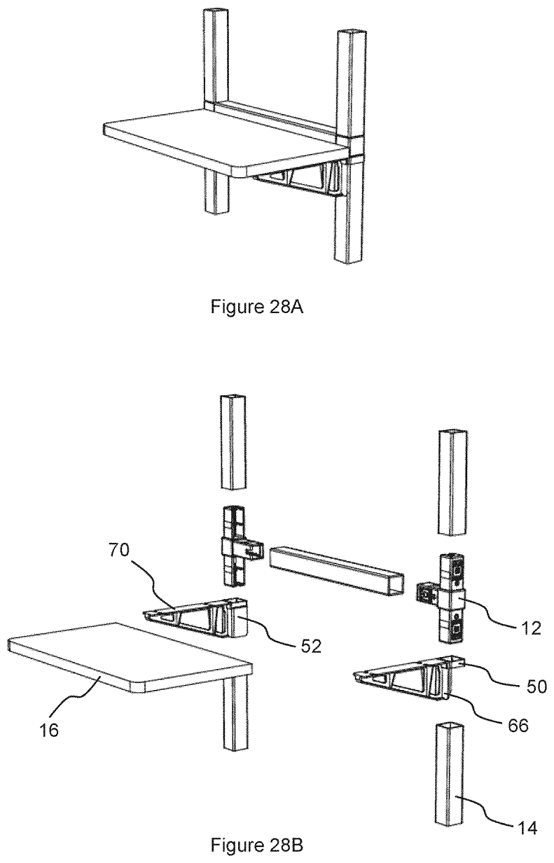

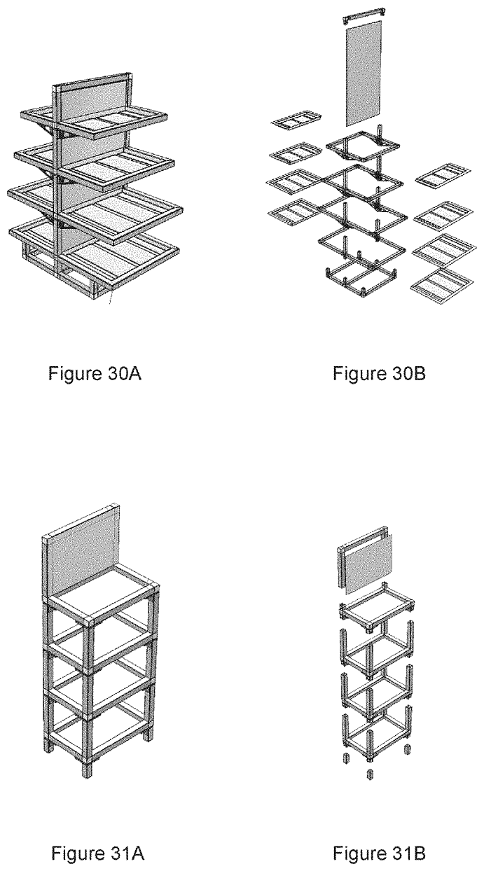

FIGS. 28A-28B show the shelf brackets of FIGS. 12A and 12B in use within an embodiment of the assembly 10, while FIGS. 30A and 30B show the shelf bracket of FIG. 12C in use within an embodiment of the assembly 10.

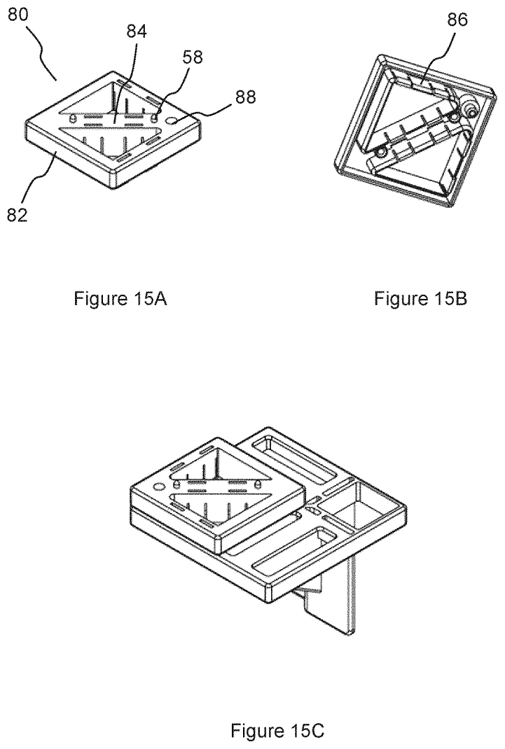

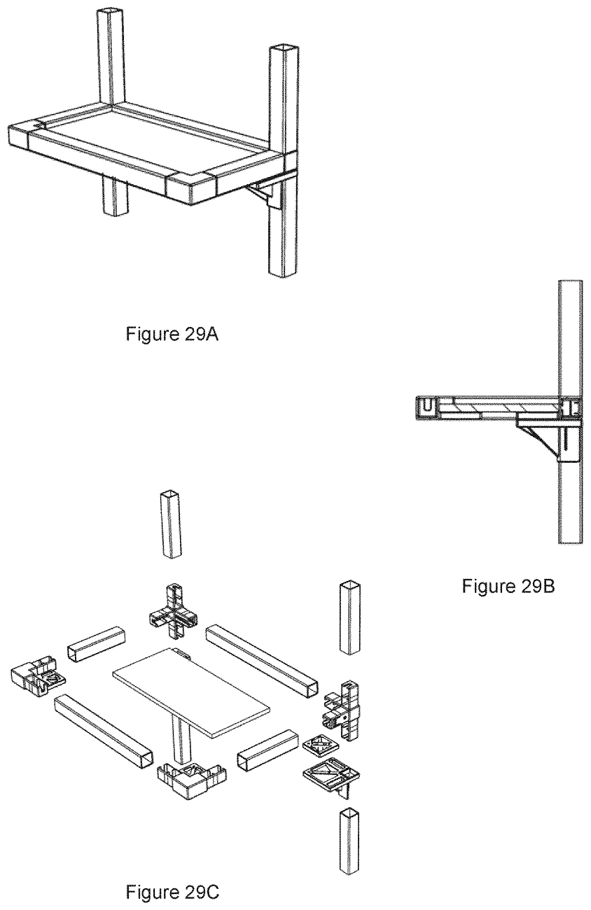

FIGS. 15A and 15B illustrate a riser 80 for use in the assembly 10. The riser 80 has a perimeter structure 82 that defines a shelf-supporting platform. A cross-brace 84 connects a pair of opposing corners. Extending downward from the underside of the riser 80 is a coupling structure 86. The coupling structure 86 is shaped and dimensioned to mate with an underlying component, such as a shelf support 48. For example, the coupling structure 86 is shaped and dimensioned to matingly fit with the riser receiving area 53 of the shelf support 48, which is the void space defined by the shelf support ribs 54. The coupling structure 86 attaches to the riser receiving area 53 of the shelf support 48 by e.g. a snap-fit means as can be seen in FIG. 15C. The riser 80 may have at least one post 58 having a pointed tip 60 that extends upwardly from the face thereof. The riser 80 may have a fastener aperture 88 that allows the riser 80 to be secured via a fastener to an underlying component. For example, when the riser 80 is installed on a shelf support 48, the fastener aperture 88 aligns with the hardware aperture 57. FIGS. 29A-29C show the riser 80 in use within an embodiment of the assembly 10.

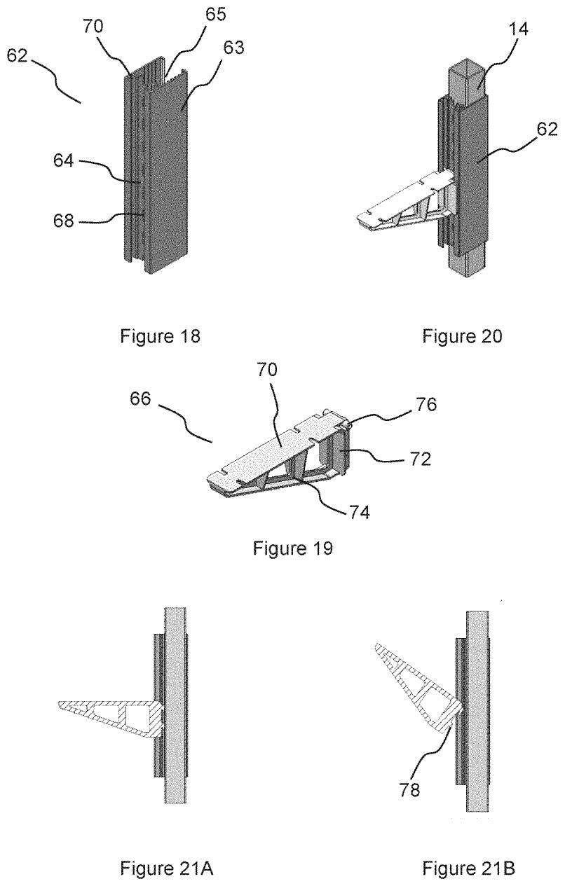

The assembly 10 may include a mounting bracket 62 as shown in FIG. 18. The mounting bracket 62 is shaped and dimensioned to snugly yet slidably engage with a vertical support 14. The mounting bracket 62 maintains its position on the vertical support 14 with a friction fit.

FIG. 19 shows an adjustable shelf bracket 66 that couples with the mounting bracket 62 to provide further shelf support. The shelf bracket 66 is generally L-shaped forming a cantilevered structure, having a shelf bracket face 70 and a brace plate 72 that are substantially perpendicular with each other. At least one guide 76 is connected to the brace plate 72. A plurality of struts 74 connect the shelf bracket face 68 and the brace plate 72.

The mounting bracket 62 includes sides 63 that define a cuff 65 that slidably engages a support 14, and the opposing side of the mounting bracket 62 has a track 64 that receives the adjustable shelf bracket 66. The track 64 has internal channels 70 on opposing sides thereof. The guides 76 from the shelf bracket 66 are placed in the channels 70 allowing the shelf bracket to move up and down the track 64 (see FIG. 20).

The shelf bracket 66 has securing members 78, such as hooks, extending from the brace plate 72. When the shelf bracket 66 is in a desired position, the securing 78 members engage with corresponding slots 68 that are located inside the track 64 (see FIG. 21B). The shelf bracket 66 is now secured within the mounting bracket 62 (see FIG. 21A), and is able to support e.g. a shelving member 16. FIGS. 32A and 32B show the mounting bracket 62 and shelf bracket 66 in use within an embodiment of the assembly 10.

Although a specific embodiment is herein shown and described, variations are possible.

The supports can be made of wrapped paper fibre but other materials can also be used, such as extruded plastic. The exterior of the support can be painted or powder coated. The powder coating increases stiffness and improves moisture resistance. The supports can also be impregnated with resin to improve rigidity and moisture resistance. The supports can be wrapped with printed vinyl graphics, which can contribute to their visual appeal, and also improves moisture resistance Tubes can also be produced from extruded plastic.

Connectors can be moulded in various colours and textures. Acrylonitrile butadiene styrene (ABS) is the preferred plastic but other plastics can be utilized, including fibre reinforced plastics. The connectors can also be vacuum metalized. The shelving members can be made from a variety of materials, including honeycomb paper board, wood, laminate, corrugate, MDF or plastic.

The base of the connector may be substantially planar with only two opposing faces. In this embodiment as shown in FIG. 6H, there are two legs extending outwardly in opposing directions that can couple two longitudinal supports 14. Alternatively, this planar base may have only a single leg extending outward see FIG. 6I, which would serve as a cap on an open end of a support 14.

FIGS. 13A and 13B show a hybrid connector 12 with a shelf support 48. This corner connector 12 has two legs extending outward from a base 28. The base 28 is “L” shaped, with each length of the base 28 being equivalent in dimension. The legs of the connector are generally as discussed above. Connected to the interior corner of “L” shape of the base 28 is a shelf support 48. The shelf support 48 includes shelf support ribs 54 that define a seat 56 to support a shelving member 16. The shelf support ribs also define riser receiving areas 53 that can receive coupling structures 86 from a riser 80.

FIGS. 14A and 148 show another embodiment of the shelf support bracket 66 for handling lighter loads. This embodiment includes a collar 50 connected with either a single-sided (FIG. 14A) or double-sided (FIG. 14B) supporting member 67.

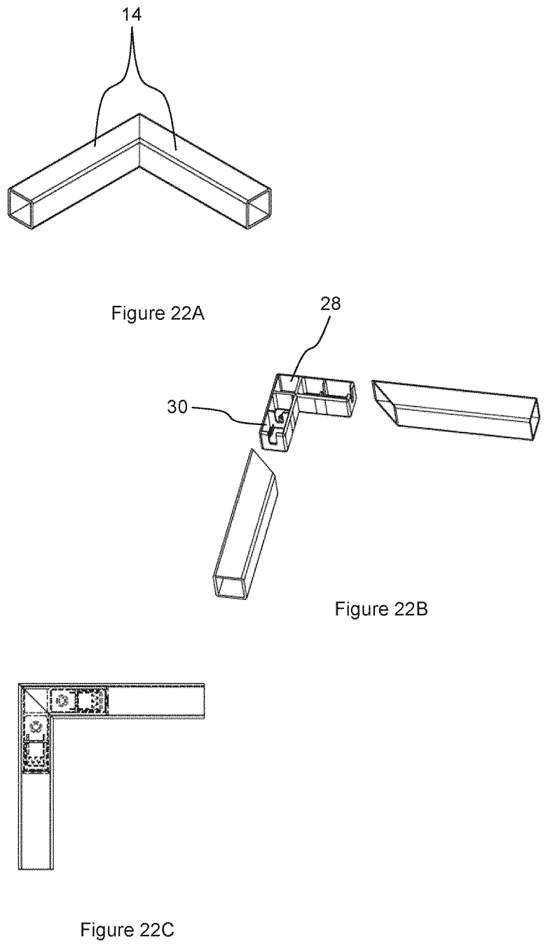

FIGS. 22A to 22C show another embodiment that can be incorporated into the assembly of the present invention. The Figures show a miter connection between two supports 14. The connector 12 is a corner connector 12 generally having the features as discussed above. However, there is no abutment 42. Rather, the legs 30 have the same exterior dimension as the base 28. The supports 14 have a miter cut, and slide over the whole of the connector 12. The supports 14 abut each other, hiding the connector 12 from view.

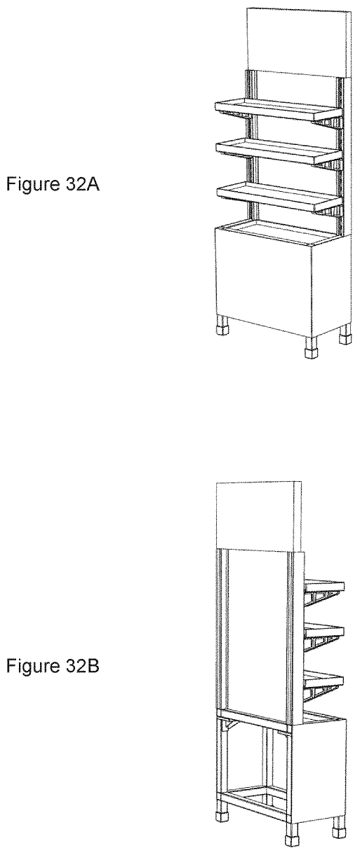

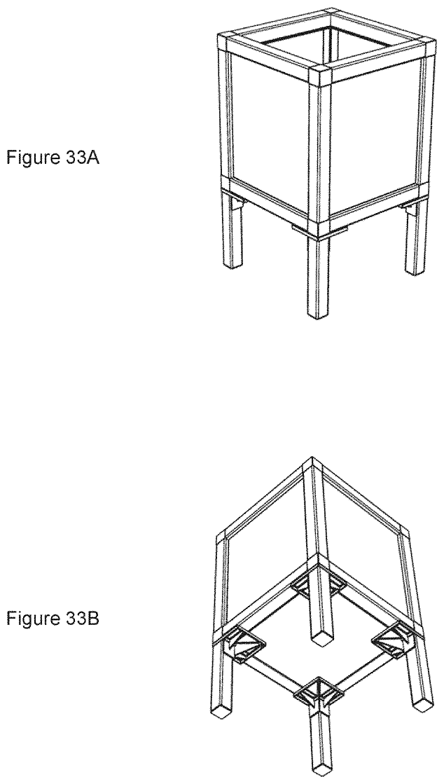

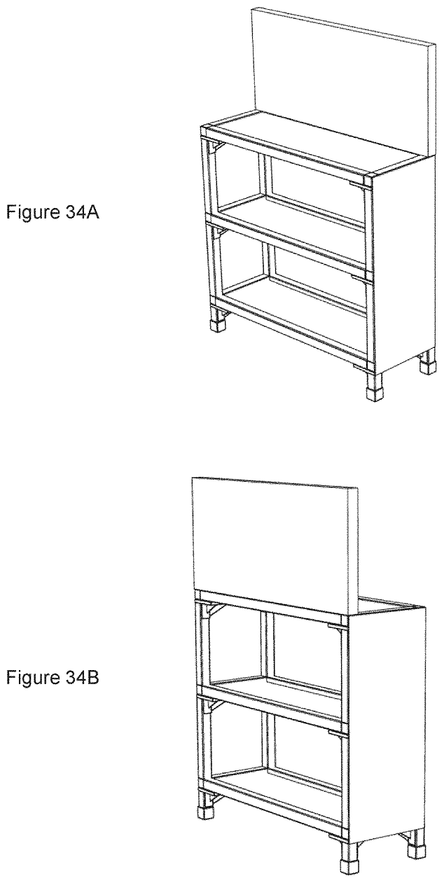

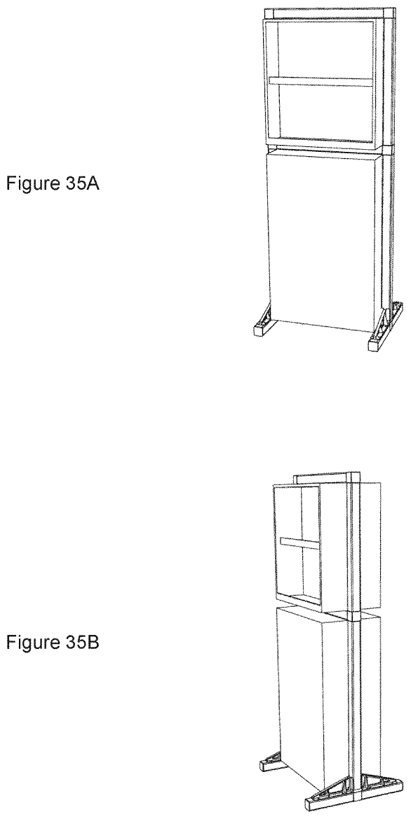

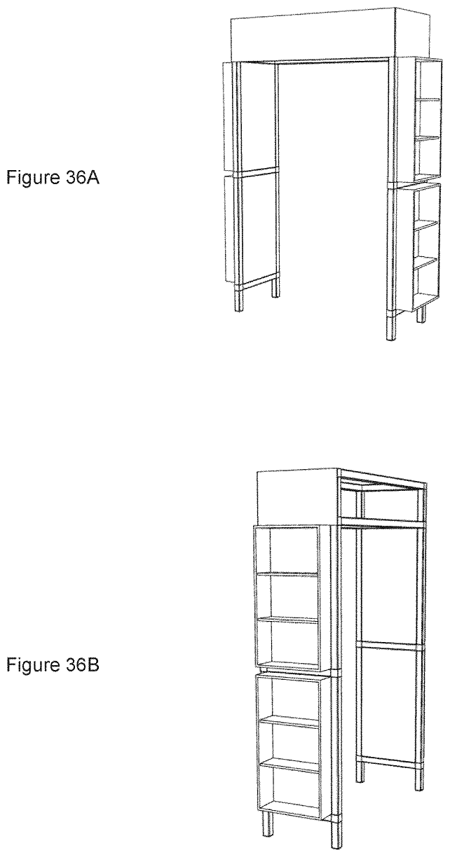

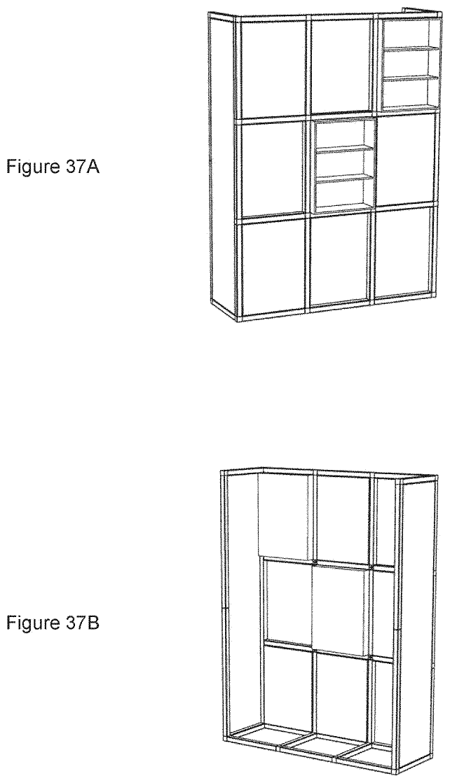

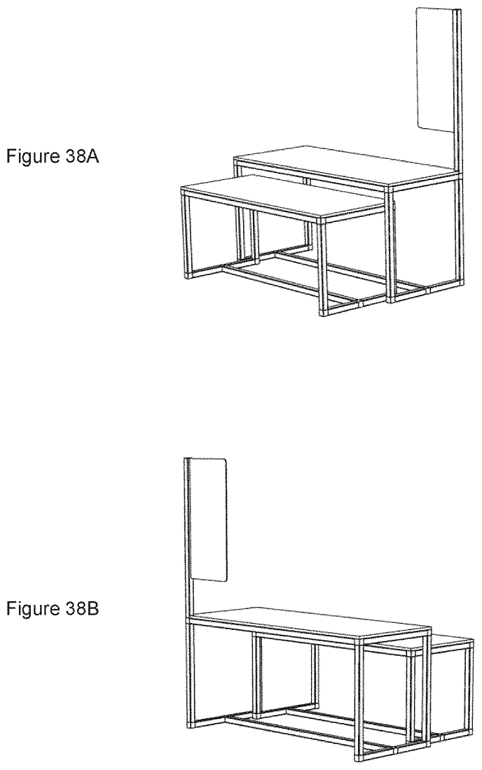

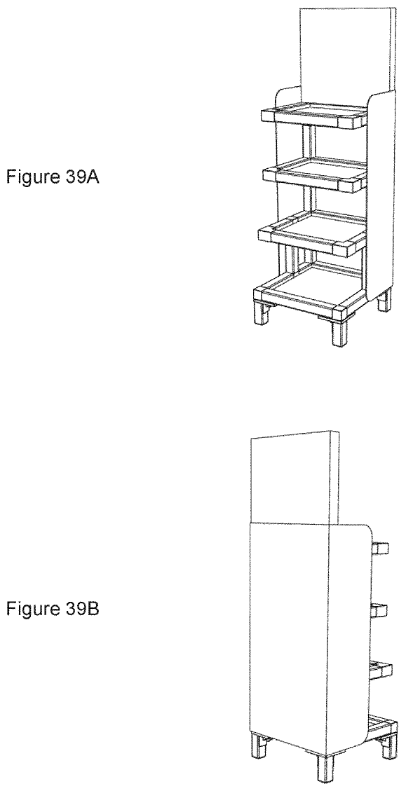

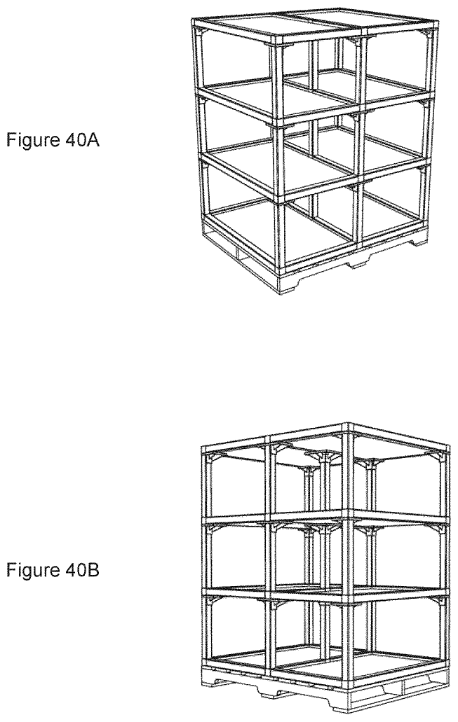

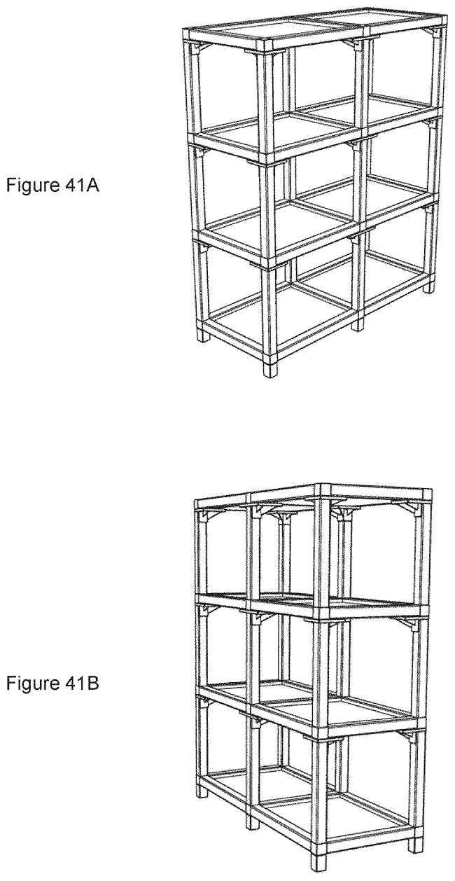

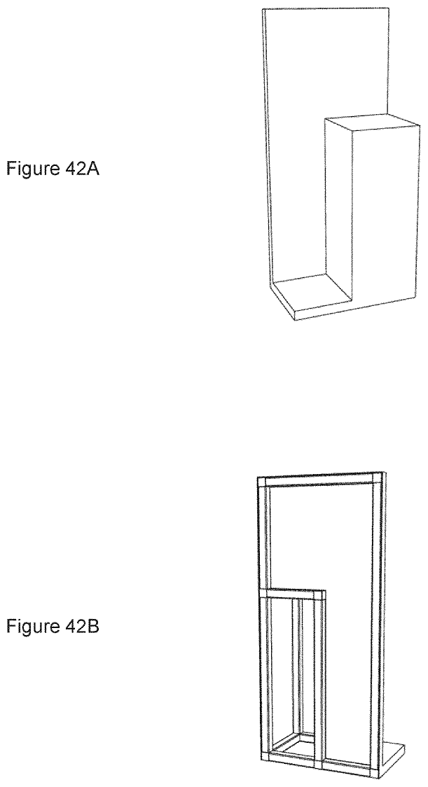

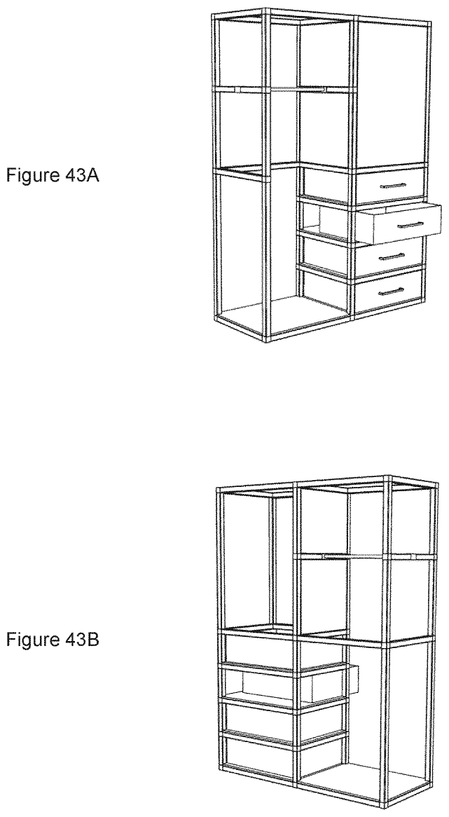

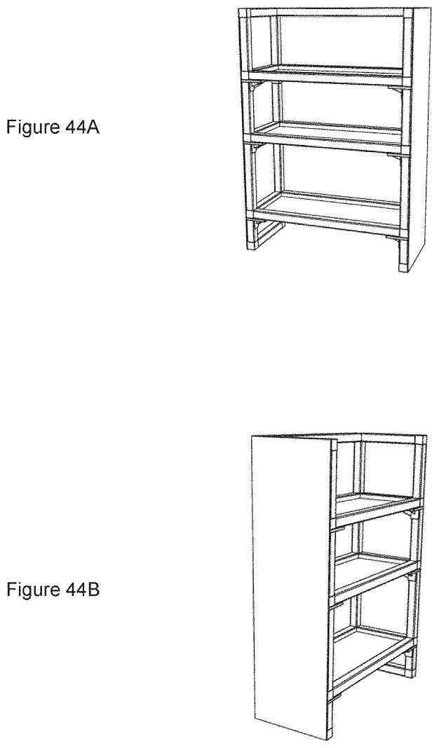

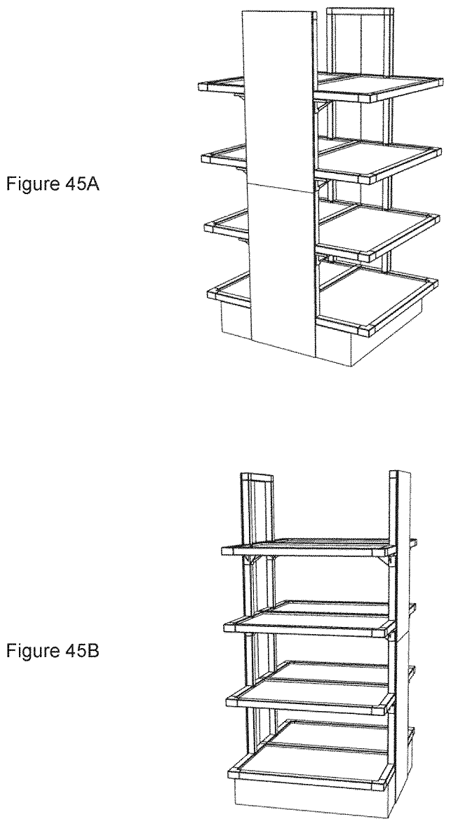

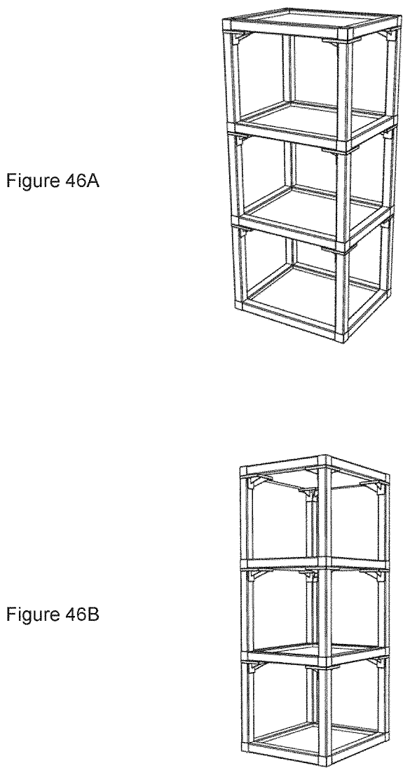

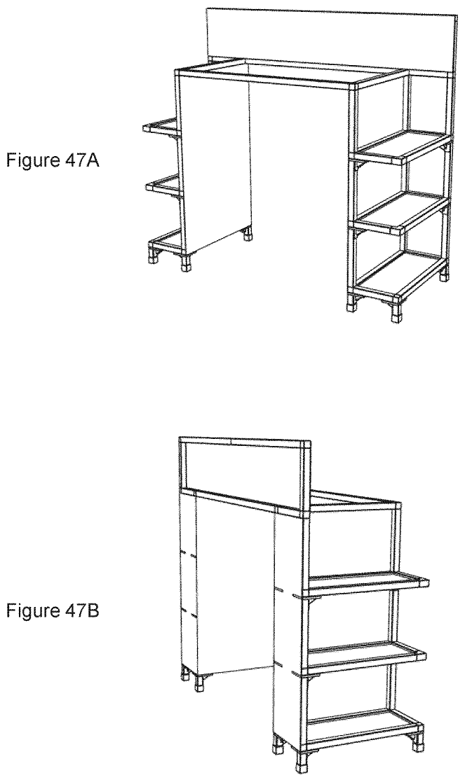

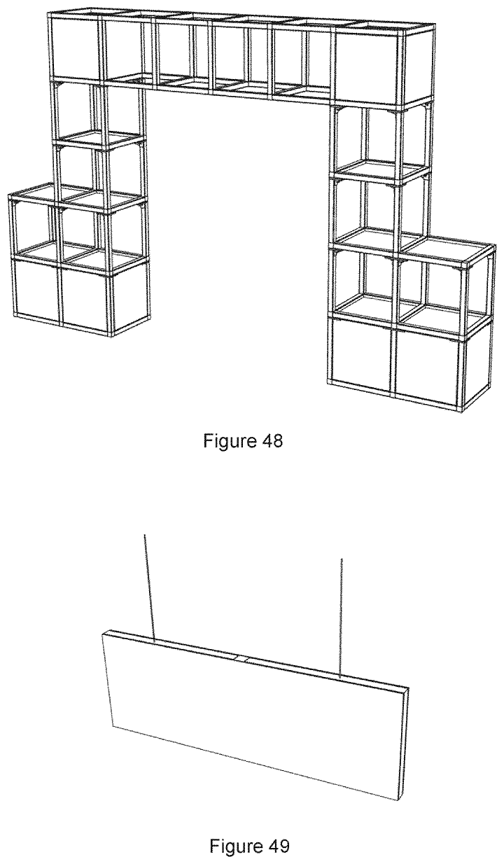

In addition, the modular nature of the assembly 10 makes it versatile, with the ability to construct a number of structures, such as retail displays, trade show booths, pop up stores, furniture (tables, book cases, shelving), retail display fixtures, retail signage (sign frames), and the like. FIGS. 30 to 49 illustrate some exemplary assemblies that can be built with combinations of the components as described above. On this basis, any combination of the components as described above can be included in an unassembled state and sold in a kit. A kit comprising some combination of the components, such as a plurality of connectors 12 and supports 14, will allow the end user to create the desired assembly 10.

1. A modular frame assembly comprising:
a plurality of supports, each support defining a socket, the socket being defined by an interior surface; and
a connector for interconnecting the supports.

2. The modular frame assembly according to claim 1, wherein the connector comprises:
a base;
a plurality of legs extending outwardly from the base, each leg defining a plug having an exterior surface that has a generally constant profile throughout the length of the leg; and
a member coupled to the leg and that is movable between an engaged position in which it projects interiorly of the exterior surface, and a disengaged position in which it is flush with the exterior surface, the member being biased to the disengaged position.

3. The modular frame assembly according to claim 2, wherein an outer surface of the member has one or more gripping elements that, when the plug is received by a socket, engage with the interior surface of the support defining the socket.

4. The modular frame assembly according to claim 3, wherein the member is a tab integrally formed with the leg.

5. The modular frame assembly according to claim 3, wherein the one or more gripping elements is a plurality of gripping elements.

6. The modular frame assembly according to claim 3, wherein the gripping elements are barbs.

7. The modular frame assembly according to claim 2, wherein the connector is a corner connector comprising at least two legs disposed in perpendicular relation to one another.

8. The modular frame assembly according to claim 2, wherein the connector is a central connector comprising at least three legs.

9. The modular frame assembly according to claim 1, wherein the support is a tubular member with an opening at each end to receive the connector, each end defining a socket.

10. The modular frame assembly according to claim 1, further comprising a shelf support, the shelf support comprising:
a collar; and
shelf support ribs connected to the collar, which interconnect to form a shelf seat.

11. The modular frame assembly according to claim 10, wherein a sleeve extends downward from the collar.

12. The modular frame assembly according to claim 10, wherein the shelf support comprises a post normal to an upper face of the shelf seat, the post having a sharpened tip.

13. The modular frame assembly according to claim 10, further comprising a shelving member mounted to the shelf support.

14. The modular frame assembly according to claim 1, further comprising a mounting bracket, the mounting bracket comprises:
a longitudinal member, which includes a cuff along the length of a first side that slidably engages the support, and a track along the length of a second side.

15. The modular frame assembly according to claim 14, further comprising an adjustable shelf bracket, the adjustable shelf bracket comprises:
a shelf bracket face;
a brace plate extending downwardly forming a generally cantilevered structure; and
at least one guide connected to the brace plate that is received by the track.

16. A connector comprising:
a base;
a plurality of legs extending outwardly from the base, each leg defining a plug having an exterior surface that has a generally constant profile throughout the length of the leg; and
a member that is movable between an engaged position in which it lies interiorly of the exterior surface, and a disengaged position in which it is flush with the exterior surface, the member being biased to the disengaged position.

17. A system comprising:
supports, each support being defined by a fibre tube having an interior surface and defining, at each end, a socket; and
connectors, each connector having
a base;
a plurality of legs extending outwardly from the base, each leg
defining a plug having an exterior surface that has a generally constant profile throughout the length of the leg and is adapted to be received in close-fitting relation by a socket; and
having a member that is movable between an engaged position in which it lies interiorly of the exterior surface, and a disengaged position in which it is flush with the exterior surface, the member being biased to the disengaged position.

18. The connector according to claim 16, wherein the member has a gripping element that, when the plug is received by a socket, engages with the interior surface of the support defining the socket.

19. The connector according to claim 16, wherein the leg is tubular and the member is a tab integrally formed with the leg.

20. The connector according to claim 17, wherein the gripping element is a barb.

21. A kit for constructing a frame assembly, the kit comprising:
a plurality of supports;
a connector for interconnecting the supports.

22. The kit according to claim 20, further comprising a shelf support, a mounting bracket, and/or an adjustable shelf bracket.
